(19) United States
(12) Patent Application Publication
(10) Pub. No.: US 2020/0387295 A1
(43) Pub. Date: Dec. 10, 2020

(54) DESIGN ADJUSTMENT BASED ON USER-SPECIFIED DIRECTION OF CHANGE

(71) Applicant: salesforce.com, inc., San Francisco, CA (US)

(72) Inventors: Owen Winne Schoppe, Orinda, CA (US); Brian J. Lonsdorf, Belmont, CA (US); Sönke Rohde, San Francisco, CA (US)

(21) Appl. No.: 16/431,958

(22) Filed: Jun. 5, 2019

(51) Int. Cl. G06F 3/0484

(52) U.S. Cl. CPC G06F 3/04847; G06F 3/0482; G06F 2203/04804; G06F 3/04845

(57) ABSTRACT

Disclosed techniques relate to customization of user interface designs based on user input that specifies high-level design properties. In some embodiments, a system displays a user interface in a user interface customization program. In some embodiments, based on user input via a customization interface element that specifies a direction or change for a design property, the system performs an adjustment to formatting parameters for the user interface, where the user input does not explicitly specify the adjustment to the formatting parameters. The system may display an adjusted user interface that exhibits the adjusted formatting parameters.

### BACKGROUND

### Technical Field

Embodiments described herein relate to design technology and, in particular, to automated adjustment of low level parameters such as user interface parameters.

### Description of the Related Art

User interfaces are often generated by multiple skilled designers, e.g., to combine quality coding techniques with graphical design to achieve desired functionality while pleasing the eye, achieving branding goals, or promoting desired user behaviors. Users or designers may have ideas for the general direction of desired changes to an interface style, but actually implementing these changes may be technically difficult or time consuming.

### BRIEF DESCRIPTION OF THE DRAWINGS

FIG. 1 is a block diagram illustrating an example user interface customization module, according to some embodiments.

FIG. 2 is a diagram illustrating an example user interface with a brush element for user interface customization, according to some embodiments.

FIG. 3 is a diagram illustrating example genetic function module, according to some embodiments.

FIG. 4 is a flow diagram illustrating an example method for customizing a user interface, according to some embodiments.

FIG. 5 is a block diagram illustrating an example computing system, according to some embodiments.

This disclosure includes references to “one embodiment,” “a particular embodiment,” “some embodiments,” “various embodiments,” “an embodiment,” etc. The appearances of these phrases do not necessarily refer to the same embodiment. Particular features, structures, or characteristics may be combined in any suitable manner consistent with this disclosure.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. For example, a “user interface customization module configured to adjust formatting parameters” is intended to cover, for example, equipment that has a program code or circuitry that performs this function during operation, even if the circuitry in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible. The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke Section 112(f) during prosecution, it will recite claim elements using the “means for” [performing a function] construct.

It is to be understood that the present disclosure is not limited to particular devices or methods, which may, of course, vary. It is also to be understood that the terminology used herein is for the purpose of describing particular embodiments only, and is not intended to be limiting. As used herein, the singular forms “a”, “an”, and “the” include singular and plural referents unless the context clearly dictates otherwise. Furthermore, the words “can” and “may” are used throughout this application in a permissive sense (i.e., having the potential to, being able to), not in a mandatory sense (i.e., must). The term “include,” “comprise,” and derivations thereof, mean “including, but not limited to.” The term “coupled” means directly or indirectly connected.

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. When used herein, the term “or” is used as an inclusive or and not as an exclusive or. For example, the phrase “at least one of x, y, or z” means any one of x, y, and z, as well as any combination thereof (e.g., x and y, but not z or x, y, and z).

### DETAILED DESCRIPTION

In various embodiments discussed in detail below, a system is configured to adjust a user interface based on user input that specifies higher-order design properties, but the system does not require the user to adjust underlying formatting parameters used to achieve the desired design properties. This may allow for interface customization by users that do not have experience with user interface design or reduce design time for more experienced users. Further, the disclosed techniques may allow increased customization relative to fixed templates or themes. The disclosed techniques may also facilitate adjusting all or part of an interface to match one or more other target interfaces.

As one example, a user may interact with an interface customization element to indicate a direction and magnitude of change for an existing interface. For example, the user may move a slider element in a direction indicating a greater level of a design property such as happiness, sophistication, price focus, etc. and the system may automatically adjust formatting parameters in a multi-dimensional space to achieve the desired change. In some embodiments, the system uses disclosed techniques to guide an iterative process that uses a genetic function, e.g., to select from among multiple interface styles generated by the function at each iteration based on user input.

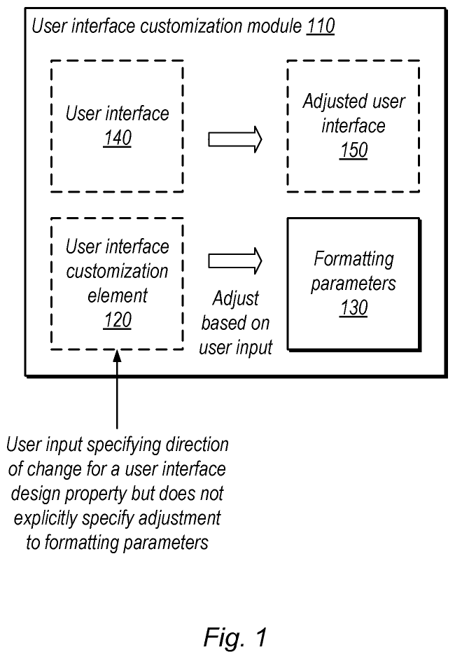

FIG. 1 is a block diagram illustrating an example user interface customization module, according to some embodiments. In the illustrated embodiment, module 110 causes display of both user interface 140 and an adjusted user interface 150 based on user interaction with a displayed user interface customization element 120. These interfaces may be displayed in parallel or at different times. The dashed lines are used to show data associated with display of these interfaces/elements. In the illustrated embodiment, module 110 also maintains formatting parameters 130.

The user input, in the illustrated embodiment, specifies a direction of change for a user interface design property, but does not explicitly specify adjustment to the formatting parameters 130 that module 110 changes based on the design property input. Module 110 adjusts formatting parameters 130 based on the user input and causes display of adjusted user interface 150 that reflects the adjustments to the formatting parameters.

For example, a user may specify that the design property “emphasis” should be increased and module 110 may increase font size and boldness formatting parameters based on this input (although the user input does not explicitly specify any changes to those two formatting parameters). In some embodiments, users may also separately specify explicit changes to formatting parameters, but the adjustments based on higher-level design property inputs are not based on explicit changes to formatting parameters.

In some embodiments, module 110 implements a rule set to determine adjustments based on higher-level user inputs. For example, rules may specify correlations between design properties and underlying formatting parameters that are to be adjusted to cause changes in the design properties. In some embodiments, the system uses random or statistical functions in combination with such rules to perturb designs based on user input in a non-deterministic fashion. In some embodiments, module 110 uses one or more machine learning engines to determine what properties to change based on user input for different design properties. For example, users may be questioned to identify which designs correspond to different design properties and their responses may be used to train a machine learning engine to adjust underlying formatting parameters to achieve certain design properties.

U.S. patent application Ser. No. 16/393,180 filed Apr. 24, 2019 is incorporated by reference herein in its entirety and discusses techniques for training a machine learning engine to score user interface elements based on user perspective. Similar techniques may be used for various design properties and adjustments may be determined to move scores for one or more design properties in a desired direction (e.g., to have more visual prominence).

Module 110 may continuously or discretely move a point through a multi-dimensional space for multiple formatting parameters to move the overall style in a desired direction (e.g., where different formatting parameters correspond to different dimensions in the space and a point in the space corresponds to a set of formatting parameter values). In some embodiments, a random or pseudorandom function is used to perturb the point in space, although the random movement may be subject to constraints based on specified design properties.

Design properties may include, without limitation: visual prominence, sophistication, boldness, happiness/sadness (or any of various moods), similarity or contrast with style of a specific target interface, focus on a particular type of content (e.g., product focus, service focus, price focus, or appearance focus), etc. Formatting parameters may include, without limitation: color, size, font, boldness, border characteristics, layout (e.g., spacing or positioning), transparency, rotation, brightness, vibrancy, strikethrough, italic, shadow, resolution, etc. User input elements used to input design properties may include, without limitation: sliders, knobs, joystick, gesture-based elements (e.g., that receive swipe input), etc. Various user input elements may be infinite or finite, linear or logarithmic (or use other scaling), may or may not snap back to a center position, etc. Logarithmic scaling may allow finite control of a potentially infinite number scale.

U.S. patent application Ser. No. 16/176,760, filed Oct. 31, 2018 is incorporated by reference herein in its entirety. This '760 application discusses various techniques for automatically generating user interfaces. In various embodiments, these techniques may be used to determine adjustments to formatting parameters when adjusting a user interface based on higher-level user input for a design property. Example techniques that may be used include component-based processing, machine learning engines, etc. Further, the techniques disclosed in the '760 application may preserve visual appeal while adjusting an interface.

As used herein, the term “module” refers to circuitry configured to perform specified operations or to physical non-transitory computer readable media that store information (e.g., program instructions) that instructs other circuitry (e.g., a processor) to perform specified operations. Modules may be implemented in multiple ways, including as a hardwired circuit or as a memory having program instructions stored therein that are executable by one or more processors to perform the operations. A hardware circuit may include, for example, custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, or the like. A module may also be any suitable form of non-transitory computer readable media storing program instructions executable to perform specified operations.

Note that adjustments to the user interface may be applied to an entire interface or to portions thereof. In some embodiments, user input indicating to adjust a design property for part of a user interface may also affect other parts of the interface. For example, to increase visual prominence of one element, the system may reduce the size or change the positioning of other elements. In some embodiments, the system generates multiple adjusted interfaces or adjusted interface portions based on user adjustment of a design property and allows a user to select from the set of generated interfaces/portions. As one example discussed in detail below, a brush user interface element may be used to “paint” parts of the interface to adjust design properties for that portion of the interface.

Further, note that various techniques discussed herein in the context of user interfaces may be used to automatically generate lower-level parameters for various other types of graphical designs, including other types of electronic media, designs of physical objects, 3D-printed designs, etc. Similarly, various input techniques discussed herein via a user interface may be implemented using other types of input in other embodiments, such as plain text inputs, voice commands, etc.

### Example Brush User Interface Element

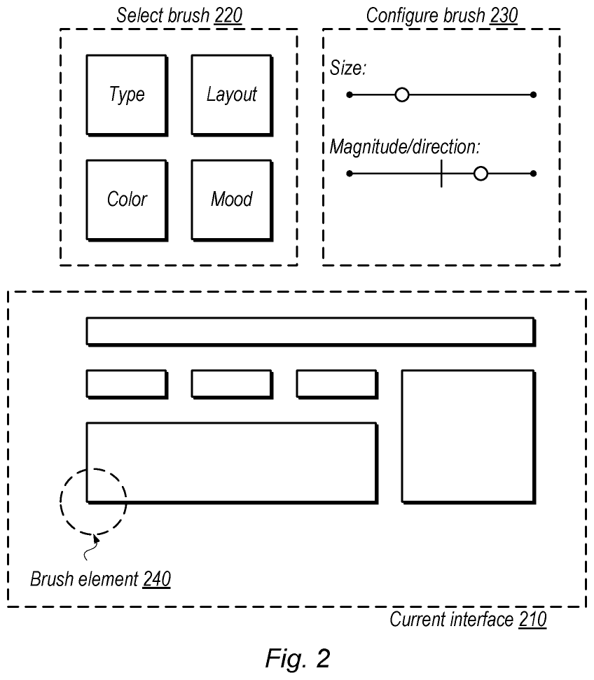

FIG. 2 is a block diagram illustrating an example interface with a brush element for receiving user input, according to some embodiments. In the illustrated embodiment, an interface shows a current interface portion 210, a select brush portion 220, and a configure brush portion 230.

Current interface 210, in the illustrated embodiment, shows the current formatting of a user interface being adjusted by a user. The system may alter current interface 210 to reflect formatting adjustments based on user input. In some embodiments, when a user selects and drags brush element 240 over interface 210 (e.g., using a mouse or touchscreen) the system may adjust formatting parameters for elements of interface 210 that underlie brush element 240.

Select brush portion 220, in the illustrated embodiment, allows for a selection from among four different types of brushes: type, layout, color, and mood. Note that these brush types are included for purposes of explanation but are not intended to limit the scope of the present disclosure. In some embodiments, a given design parameter associated with a brush corresponds to multiple lower level formatting parameters. The type brush may adjust font, text size, or boldness, for example. In some embodiments, the type brush operates according to a type hierarchy, where one direction moves up the hierarchy and the other direction moves down the hierarchy. The color type brush may adjust color, opacity, brightness, hue, or contrast, for example. The layout type brush may adjust positioning or spacing, for example. The mood type brush may adjust color, spacing, or font, for example. Note that a given brush type may be used to adjust to multiple design properties or multiple brush types may be selected and applied in parallel.

Configure brush portion 230, in the illustrated example, allows a user to adjust a size of the brush element 240 and a magnitude and direction of change. For example, moving the magnitude/direction slider to the right for a mood brush may move in a happier direction while moving this slider to the left for the mood brush may move in a more somber direction. The distance of the slider from the middle of the element may indicate the magnitude of the change. For example, brushing a given element multiple times with a lower magnitude may have a similar effect to brushing the element once with a greater magnitude. Said another way, the magnitude may specify the step size for each brushing operation. In other embodiments, the brush magnitude may be fixed and the user may specify magnitude of change by applying a brush multiple times. While the size and magnitude/direction are shown for purposes of illustration, configure brush portion 230 may include any of various brush parameters in other embodiments. Further, portion 230 may allow adjustment of different parameters for different brush types.

In some embodiments, an interface (e.g., for mobile devices) includes swipe functionality to indicate the magnitude and direction of change for a design property. For example, a user may select one or more design properties and then swipe to the right to move in one direction for those properties and left to move in another direction for those properties. The number of swipes may indicate the magnitude of the adjustment, for example.

### Example Text Formatting Parameters and Genetic Function

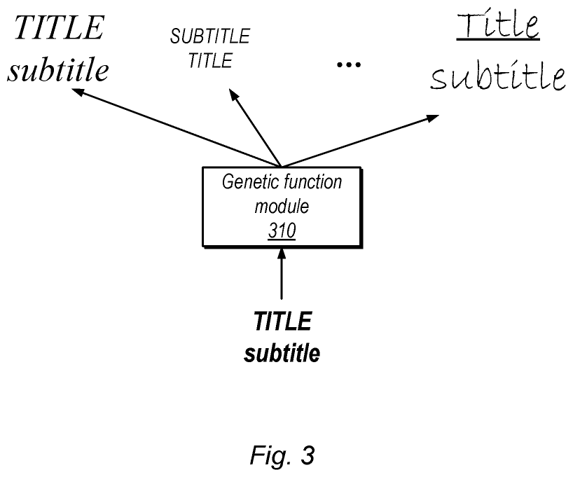

FIG. 3 is a diagram illustrating an example genetic function that generates multiple versions of an input user interface component with varied formatting parameters. Genetic functions typically create a population (e.g., of multiple sets of formatting parameters), measure, breed, and mutate repeatedly. Each jump may not take a linear path and fitness of each design may be evaluated (automatically or by a user) to inform subsequent jumps.

In the illustrated example, each component includes a title element and a subtitle element. In this example, formatting parameters that are varied for different outputs include font, size, underlining, italics, and relative positioning of the elements. In some embodiments, the system implements genetic functions to generate multiple points in a multi-dimensional space of formatting parameters and the output components correspond to those points. The system may automatically select a subset of the outputs based on the user input in one or more iterations or a user may select a subset of the outputs in one or more iterations. In some embodiments, the higher-level design properties specified by the user provide a limit on perturbations allowed in an iteration or a set of iterations used by the genetic function module 310 to generate a new population.

### Example Method

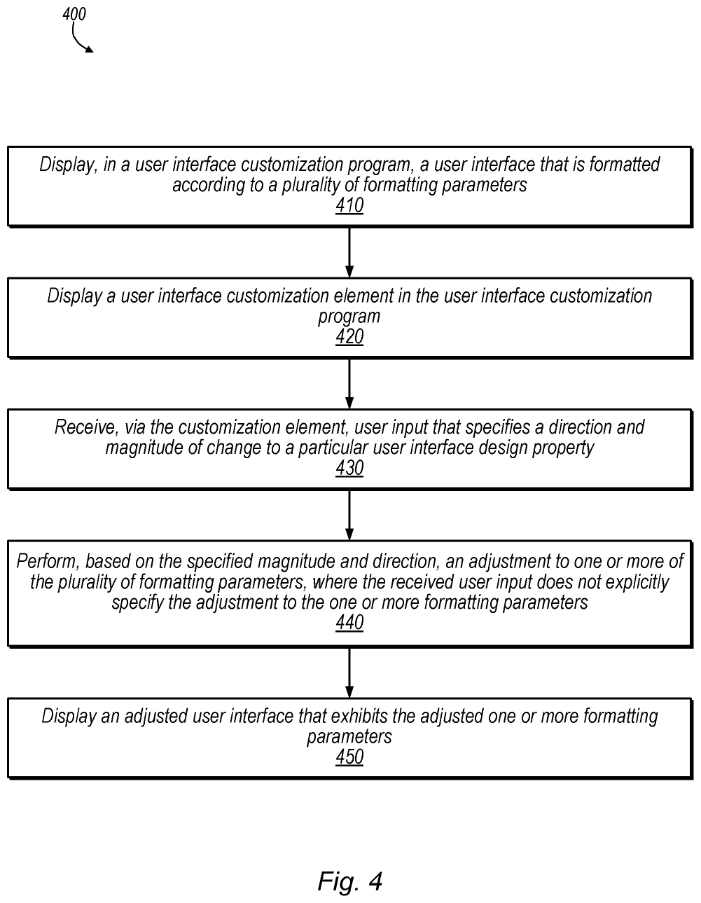

FIG. 4 is a flow diagram illustrating a method 400 for customizing a user interface, according to some embodiments. The method shown in FIG. 4 may be used in conjunction with any of the computer circuitry, systems, devices, elements, or components disclosed herein, among others. In various embodiments, some of the method elements shown may be performed concurrently, in a different order than shown, or may be omitted. Additional method elements may also be performed as desired.

At 410, in the illustrated embodiment, a computer system displays, in a user interface customization program, a user interface that is formatted according to a plurality of formatting parameters. The interface may be an existing interface or an interface that has already been at least partially modified by the customization program.

At 420, in the illustrated embodiment, the system displays a user interface customization element in the user interface customization program. The user interface customization element may be a brush or a slider, for example.

At 430, in the illustrated embodiment, the system receives, via the customization element, user input that specifies a direction and magnitude of change to a particular user interface design property.

At 440, in the illustrated embodiment, the system performs, based on the specified magnitude and direction, an adjustment to one or more of the plurality of formatting parameters, where the received user input does not explicitly specify the adjustment to the one or more formatting parameters.

At 450, in the illustrated embodiment, the system displays an adjusted user interface that exhibits the adjusted one or more formatting parameters.

### Example Device

In some embodiments, any of various operations discussed herein may be performed by executing program instructions stored on a non-transitory computer readable medium. In these embodiments, the non-transitory computer-readable memory medium may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

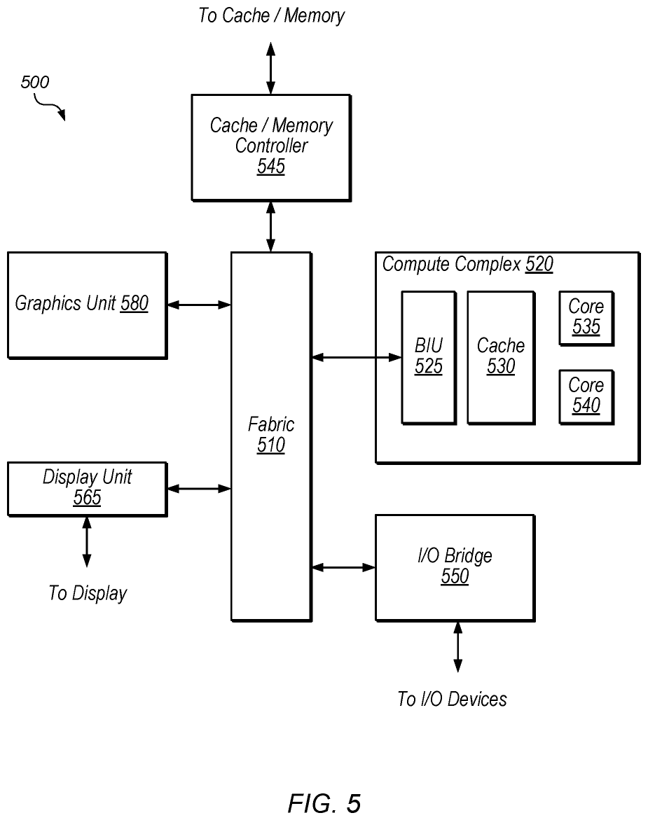

Referring now to FIG. 5, a block diagram illustrating an exemplary embodiment of a device 500 is shown. The illustrated processing elements may be used to implement all or a portion of the module of FIG. 1, in some embodiments. In some embodiments, elements of device 500 may be included within a system on a chip. In the illustrated embodiment, device 500 includes fabric 510, compute complex 520, input/output (I/O) bridge 550, cache/memory controller 545, graphics unit 580, and display unit 565.

Fabric 510 may include various interconnects, buses, MUX's, controllers, etc., and may be configured to facilitate communication between various elements of device 500. In some embodiments, portions of fabric 510 may be configured to implement various different communication protocols. In other embodiments, fabric 510 may implement a single communication protocol and elements coupled to fabric 510 may convert from the single communication protocol to other communication protocols internally.

In the illustrated embodiment, compute complex 520 includes bus interface unit (BIU) 525, cache 530, and cores 535 and 540. In various embodiments, compute complex 520 may include various numbers of processors, processor cores and/or caches. For example, compute complex 520 may include 1, 2, or 4 processor cores, or any other suitable number. In one embodiment, cache 530 is a set associative L2 cache. In some embodiments, cores 535 and/or 540 may include internal instruction and/or data caches. In some embodiments, a coherency unit (not shown) in fabric 510, cache 530, or elsewhere in device 500 may be configured to maintain coherency between various caches of device 500. BIU 525 may be configured to manage communication between compute complex 520 and other elements of device 500. Processor cores such as cores 535 and 540 may be configured to execute instructions of a particular instruction set architecture (ISA) which may include operating system instructions and user application instructions.

Cache/memory controller 545 may be configured to manage transfer of data between fabric 510 and one or more caches and/or memories. For example, cache/memory controller 545 may be coupled to an L3 cache, which may in turn be coupled to a system memory. In other embodiments, cache/memory controller 545 may be directly coupled to a memory. In some embodiments, cache/memory controller 545 may include one or more internal caches.

As used herein, the term “coupled to” may indicate one or more connections between elements, and a coupling may include intervening elements. For example, in FIG. 5, graphics unit 580 may be described as “coupled to” a memory through fabric 510 and cache/memory controller 545. In contrast, in the illustrated embodiment of FIG. 5, graphics unit 580 is “directly coupled” to fabric 510 because there are no intervening elements.

Graphics unit 580 may include one or more processors and/or one or more graphics processing units (GPU's). Graphics unit 580 may receive graphics-oriented instructions, such as OPENGL® or DIRECT3D® instructions, for example. Graphics unit 580 may execute specialized GPU instructions or perform other operations based on the received graphics-oriented instructions. Graphics unit 580 may generally be configured to process large blocks of data in parallel and may build images in a frame buffer for output to a display. Graphics unit 580 may include transform, lighting, triangle, and/or rendering engines in one or more graphics processing pipelines. Graphics unit 580 may output pixel information for display images.

Display unit 565 may be configured to read data from a frame buffer and provide a stream of pixel values for display. Display unit 565 may be configured as a display pipeline in some embodiments. Additionally, display unit 565 may be configured to blend multiple frames to produce an output frame. Further, display unit 565 may include one or more interfaces (e.g., MIPI® or embedded display port (eDP)) for coupling to a user display (e.g., a touchscreen or an external display).

I/O bridge 550 may include various elements configured to implement: universal serial bus (USB) communications, security, audio, and/or low-power always-on functionality, for example. I/O bridge 550 may also include interfaces such as pulse-width modulation (PWM), general-purpose input/output (GPIO), serial peripheral interface (SPI), and/or inter-integrated circuit (I2C), for example. Various types of peripherals and devices may be coupled to device 500 via I/O bridge 550.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A method, comprising:
displaying, by a computer system in a user interface customization program, a user interface that is formatted according to a plurality of formatting parameters;
displaying, by the computer system in the user interface customization program, a customization element;
receiving, by the computer system via the customization element, user input that specifies a direction and magnitude of change to a particular user interface design property;
performing, by the computer system based on the specified magnitude and direction, an adjustment to one or more of the plurality of formatting parameters, wherein the user input does not explicitly specify the adjustment to the one or more formatting parameters; and
displaying, by the computer system, an adjusted user interface that exhibits the adjusted one or more formatting parameters.

2. The method of claim 1, wherein the user interface element is a brush element and wherein the user input brushes one or more portions of the displayed user interface whose formatting parameters are modified to generate the adjusted user interface.

3. The method of claim 2, wherein the user input further specifies the particular user interface design property for the brush element and a size of the brush element.

4. The method of claim 1, wherein the user interface element is a slider, wherein a direction of the slider indicates the direction and a distance of the slider from a central position indicates the magnitude.

5. The method of claim 1, wherein the adjustment is performed to generate multiple sets of adjusted formatting parameters according to a genetic function, wherein one or more iterations of the genetic function are controlled based on the user input.

6. The method of claim 1, wherein the particular design property includes one or more of: a mood, visual prominence, similarity with a target interface, or focus on a particular type of content.

7. The method of claim 1, wherein the one or more of the plurality of formatting parameters includes two or more of: color, size, font, boldness, border characteristics, layout, transparency, or rotation.

8. The method of claim 1, wherein the user input includes a plurality of swipe inputs, wherein a number of the swipe inputs indicates the magnitude and a direction of the swipe inputs indicates the direction.

9. A non-transitory computer-readable medium having instructions stored thereon that are executable by a computing device to perform operations comprising:
displaying, in a user interface customization program, a user interface that is formatted according to a plurality of formatting parameters;
displaying, in the user interface customization program, a customization element;
receiving, via the customization element, user input that specifies a direction of change to a particular user interface design property;
performing, based on the specified direction, an adjustment to one or more of the plurality of formatting parameters, wherein the user input does not explicitly specify the adjustment to the one or more formatting parameters; and
displaying an adjusted user interface that exhibits the adjusted one or more formatting parameters.

10. The non-transitory computer-readable medium of claim 9, wherein the user input further specifies a magnitude of change for the particular user interface design property.

11. The non-transitory computer-readable medium of claim 9, wherein the user interface element is a brush element and wherein the user input brushes one or more portions of the displayed user interface whose formatting parameters are modified to generate the adjusted user interface.

12. The non-transitory computer-readable medium of claim 11, wherein the user input further specifies the particular user interface design property for the brush element and a size of the brush element.

13. The non-transitory computer-readable medium of claim 9, wherein the user input includes one or more swipe inputs.

14. The non-transitory computer-readable medium of claim 9, wherein the adjustment is performed to generate multiple sets of adjusted formatting parameters according to a genetic function, wherein one or more iterations of the genetic function are controlled based on the user input.

15. The non-transitory computer-readable medium of claim 9, wherein the particular design property is similarity with another interface.

16. The non-transitory computer-readable medium of claim 9, wherein the one or more of the plurality of formatting parameters include: font, layout, and transparency.

17. An apparatus, comprising:
one or more processors; and
one or more memories having instructions stored thereon that are executable by the one or more processors to:
display, in a user interface customization program, a user interface that is formatted according to a plurality of formatting parameters;
display, in the user interface customization program, a customization element;
receive, via the customization element, user input that specifies a direction and magnitude of change to a particular user interface design property;
perform, based on the specified magnitude and direction, an adjustment to one or more of the plurality of formatting parameters, wherein the user input does not explicitly specify the adjustment to the one or more formatting parameters; and
display an adjusted user interface that exhibits the adjusted one or more formatting parameters.

18. The apparatus of claim 17, wherein the user interface element is a brush element and the user input specifies the magnitude based on a number of brush operations applied to one or more user interface elements.

19. The apparatus of claim 17, wherein the adjustment is performed to generate multiple sets of adjusted formatting parameters according to a genetic function, wherein one or more iterations of the genetic function are controlled based on the user input.

20. The apparatus of claim 17, wherein the user input includes a plurality of swipe inputs, wherein a number of the swipe inputs indicates the magnitude and a direction of the swipe inputs indicates the direction.
